(19) United States
(12) Patent Application Publication
(10) Pub. No.: US 2025/0368116 A1
(43) Pub. Date: Dec. 4, 2025

(54) CUPHOLDER WITH ADJUSTABLE FEATURES

(71) Applicant: Essentially Engineered, LLC, Cheyenne, WY (US)

(72) Inventor: Jacob LOVASZ, Arvada, CO (US)

(21) Appl. No.: 18/733,488

(22) Filed: Jun. 4, 2024

(51) Int. Cl. B60N 3/10

(52) U.S. Cl. CPC B60N 3/103

(57) ABSTRACT

A cupholder for use with a vehicle has a cupholder section, an adaptable base, a first removable spacer, and a fastener to attach the cupholder section to the adaptable base, wherein the fastener passes through a first hole in the first removable spacer. wherein the first hole is substantially in the center of the first removable spacer. The cupholder section has a plurality of recesses, and the first removable spacer has a plurality of protrusions, wherein the plurality of recesses are configured to engage a first subset of the plurality of protrusions in a first configuration and a second subset of the plurality of protrusions in a second configuration, whereby the cupholder section may be positioned on-center relative to the first removable spacer in the first configuration or off-center relative to the first removable spacer in the second configuration, respectively. A related system is described.

### TECHNICAL FIELD

Embodiments herein are related to cupholders for use in vehicles.

### SUMMARY

An exemplary cupholder for use with a vehicle has a cupholder section, an adaptable base, a first removable spacer, and a fastener. The cupholder section has an internal volume shaped and configured to receive a beverage container. The adaptable base has an envelope diameter and a plurality of legs configured to expand and retract whereby the envelope diameter of the adaptable base is configured to expand between a minimum envelope diameter and a maximum envelope diameter. The first removable spacer is positioned between the adaptable base and the cupholder section. The fastener is shaped and positioned to attach the cupholder section to the adaptable base, wherein the fastener passes through a first hole in the first removable spacer. The first hole is substantially in the center of the first removable spacer. The cupholder section has a plurality of recesses, and the first removable spacer has a plurality of protrusions, wherein the plurality of recesses are configured to engage a first subset of the plurality of protrusions in a first configuration and a second subset of the plurality of protrusions in a second configuration, whereby the cupholder section may be positioned on-center relative to the first removable spacer in the first configuration or off-center relative to the first removable spacer in the second configuration, respectively. The cupholder section has a first hole and a second hole, wherein the fastener passes through the first hole when the cupholder section is in the first configuration, and wherein the fastener passes through the second hole when the cupholder section is in the second configuration. The first hole in the cupholder section is on-center relative to the envelope diameter of the adaptable base. None of the plurality of recesses in the cupholder section are on-center relative to the envelope diameter of the adaptable base when the cupholder section is in the first configuration and when the cupholder section is in the second configuration.

An exemplary system has the cupholder described in the preceding paragraph, as well as printed instructions for adding a second removable spacer, printed instructions for removing the first removable spacer, a second fastener configured for use when the first removable spacer is removed, whereby no spacer is in use, and a third fastener configured for use when the second removable spacer is added, whereby two spacers are in use.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a perspective view of an exemplary cupholder;

FIG. 2 is a side section view thereof;

FIG. 3 is a perspective exploded view thereof;

FIG. 4 is a top perspective view of a spacer used in the cupholder in FIG. 1;

FIG. 5 is a bottom perspective view of the spacer in FIG. 4;

FIG. 6 is a top perspective view of an adaptable base used in the cupholder in FIG. 1;

FIG. 7 is a bottom perspective view of a cupholder section used in the cupholder in FIG. 1; and

FIG. 8 is a schematic of an exemplary system containing the cupholder in FIG. 1.

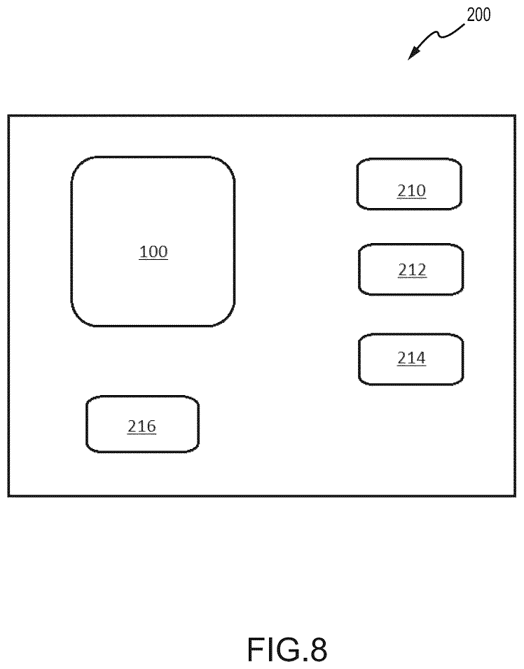

### DETAILED DESCRIPTION

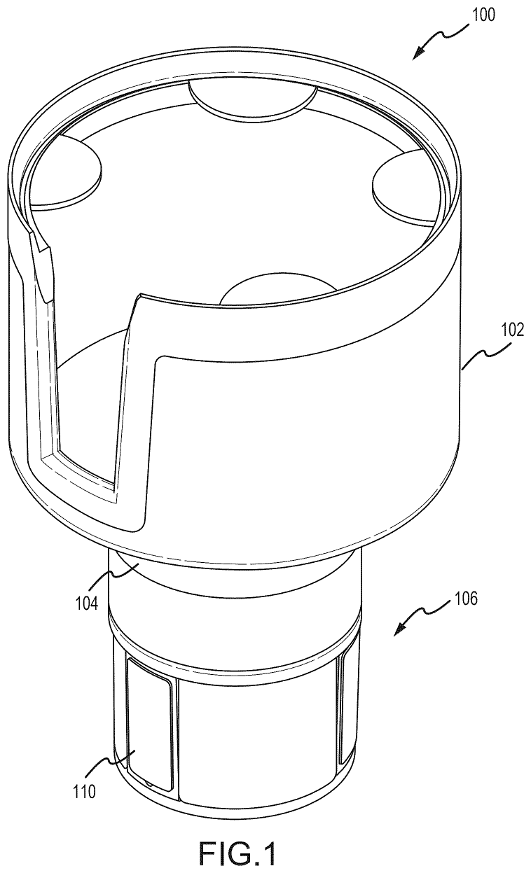

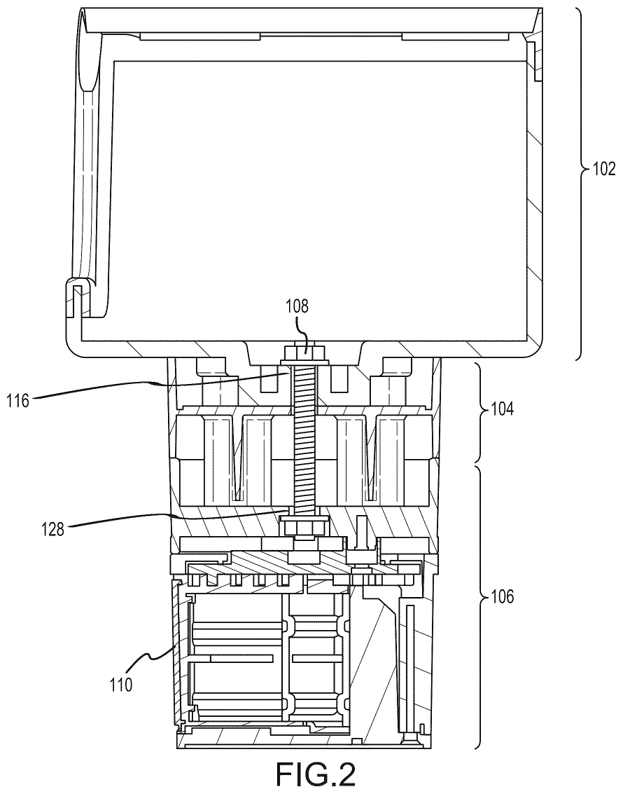

With reference now to FIG. 1 and FIG. 2, a cupholder 100 for use with a vehicle is described in detail. The cupholder 100 has a cupholder section 102, a first removable spacer 104, an adaptable base 106, and a fastener 108.

The cupholder section 102 has an internal volume shaped and configured to receive a beverage container (not shown) as is understood by those of skill in the art.

The adaptable base 106 has an envelope diameter when viewed longitudinally from an end of the cupholder 100 and a plurality of legs 110 configured to expand and retract, whereby the envelope diameter of the adaptable base 106 is configured to expand between a minimum envelope diameter and a maximum envelope diameter in a manner known to those of skill in the art.

In some embodiments, the first removable spacer 104 may be positioned between the adaptable base and the cupholder section 102.

As can be best understood from FIG. 2, the fastener is shaped and positioned to attach or affix the cupholder section 102 to the adaptable base 106 by passing through a first hole 116 in the first removable spacer 104, the first hole 116 in the first removable spacer 104 being substantially in the center of the first removable spacer 104.

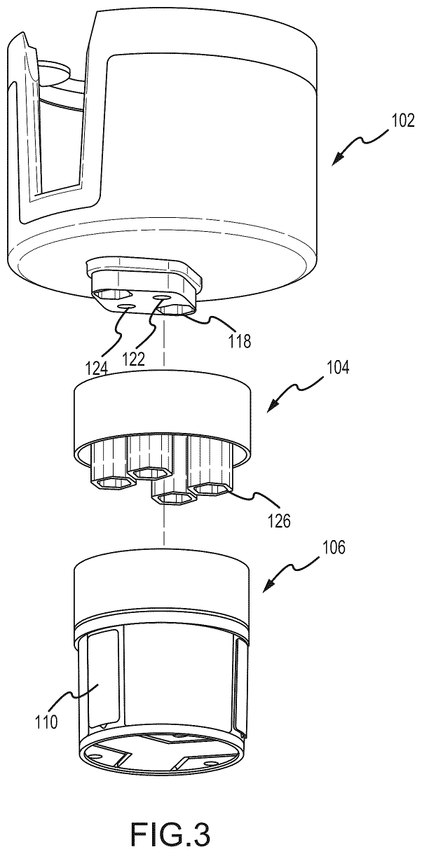

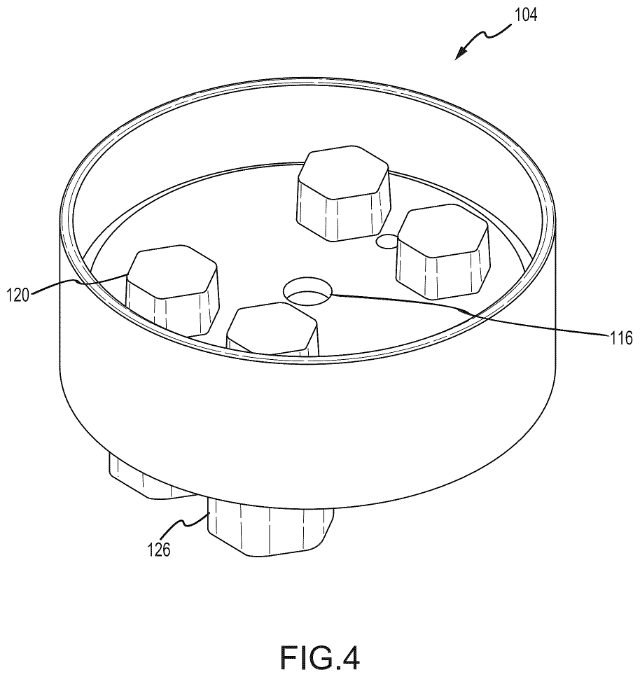

As best seen in FIG. 3 and FIG. 4, the cupholder section 102 has a plurality of recesses 118, and the first removable spacer 104 has a plurality of protrusions 120, wherein the plurality of recesses 118 are configured to engage a first subset of the plurality of protrusions 120 in a first configuration and a second subset of the plurality of protrusions in a second configuration, whereby the cupholder section 102 may be positioned on-center relative to the first removable spacer 104 in the first configuration or off-center relative to the first removable spacer 104 in the second configuration, respectively.

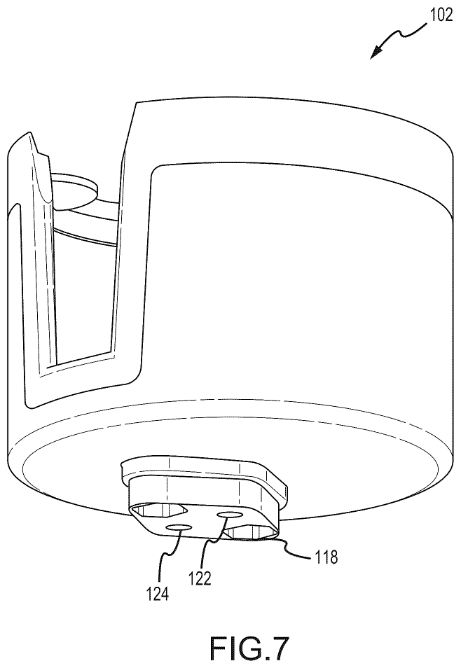

The cupholder section 102 has a first hole 122 and a second hole 124, wherein the fastener 108 passes through the first hole 122 when the cupholder section 102 is in the first configuration, and wherein the fastener 108 passes through the second hole 124 when the cupholder section 102 is in the second configuration. Additionally, the first hole 122 in the cupholder section is on-center relative to the envelope diameter of the adaptable base 106. See also FIG. 7.

In some embodiments, none of the plurality of recesses 118 in the cupholder section 102 are on-center relative to the envelope diameter of the adaptable base regardless of whether the cupholder section 102 is in the first configuration or the second configuration.

In some embodiments, the cupholder 100 may include a second removable spacer (not shown) adjacent the first removable spacer 104. The second removable spacer may be identical to the first removable spacer 104 and may be positioned between the first removable spacer 104 and the adaptable base 106. Alternatively, the second removable spacer may be positioned between the first removable spacer 104 and the cupholder section 102.

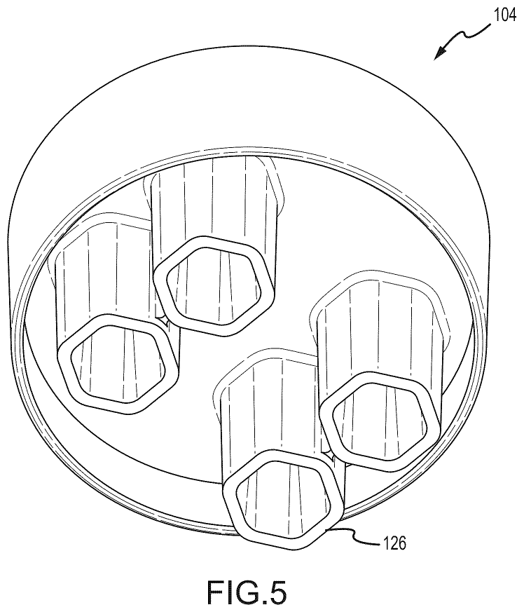

In some embodiments, the first removable spacer 104 has a plurality of hollow columns 126 extending from a side opposing a side comprising the plurality of protrusions 120. These hollow columns may be configured to engage a plurality of protrusions in the second removable spacer. (E.g. the second removable spacer may have protrusions identical to the protrusions 120 on the first removable spacer 104.) See also FIG. 5.

In some embodiments, the first spacer 104 and the second spacer are substantially made of molded plastic.

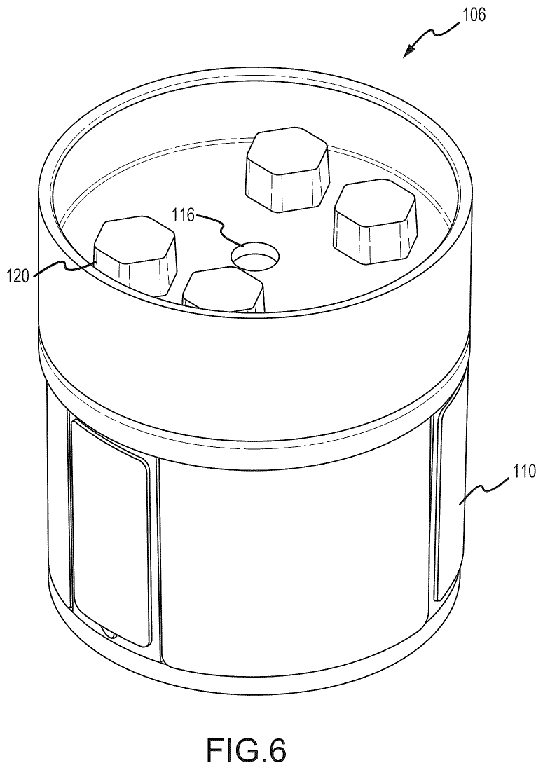

In some embodiments, the plurality of protrusions 120 in the first spacer 104 comprises four protrusions, each protrusion having a polygonal shape when viewed from a topside of the first spacer. See e.g. FIG. 6.

Returning to FIG. 2, in some embodiments, the fastener 108 is a screw, and the adaptable base 108 has a threaded insert 128 to receive a portion of the screw 108. The threaded insert 128 may be substantially made of a metallic material.

In some embodiments, a cupholder system for use with a vehicle is provided. The cupholder system may include the cupholder 100 as previously described herein. The fastener 108 may be a first fastener. In addition, the system 200 may include printed instructions for adding a second removable spacer 210. The system 200 may include printed instructions for removing the first removable spacer 212. The system 200 may include a second fastener 214 configured for use when the first removable spacer is removed, whereby no spacer is in use. The system 200 may include a third fastener 216 configured for use when the second removable spacer is added, whereby two spacers are in use.

The fasteners 108, 214, 216 may be screws, each screw having a different length.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “attachment mechanism” should be understood to encompass disclosure of the act of “attaching”—whether explicitly discussed or not—and, conversely, were there only disclosure of the act of “attaching”, such a disclosure should be understood to encompass disclosure of a “attaching mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only. The claim shall also read on a device that requires “A+B”. The claim shall also read on a device that requires “A+B+C”, and so forth.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

1. A cupholder for use with a vehicle, comprising:
a cupholder section having an internal volume shaped and configured to receive a beverage container;
an adaptable base having an envelope diameter and a plurality of legs configured to expand and retract whereby the envelope diameter of the adaptable base is configured to expand between a minimum envelope diameter and a maximum envelope diameter;
a first removable spacer, the first removable spacer positioned between the adaptable base and the cupholder section;
a fastener shaped and positioned to attach the cupholder section to the adaptable base, wherein the fastener passes through a first hole in the first removable spacer;
wherein the first hole is substantially in the center of the first removable spacer;
wherein the cupholder section has a plurality of recesses, and the first removable spacer has a plurality of protrusions, wherein the plurality of recesses are configured to engage a first subset of the plurality of protrusions in a first configuration and a second subset of the plurality of protrusions in a second configuration, whereby the cupholder section may be positioned on-center relative to the first removable spacer in the first configuration or off-center relative to the first removable spacer in the second configuration, respectively;
wherein the cupholder section has a first hole and a second hole, wherein the fastener passes through the first hole when the cupholder section is in the first configuration, and wherein the fastener passes through the second hole when the cupholder section is in the second configuration;
wherein the first hole in the cupholder section is on-center relative to the envelope diameter of the adaptable base; and
none of the plurality of recesses in the cupholder section are on-center relative to the envelope diameter of the adaptable base when the cupholder section is in the first configuration and when the cupholder section is in the second configuration.

2. The cupholder of claim 1, further comprising:
a second removable spacer adjacent the first removable spacer.

3. The cupholder of claim 2, wherein:
the first removable spacer comprises a plurality of hollow columns extending from a side opposing a side comprising the plurality of protrusions;
the second removable spacer comprises a plurality of protrusions; and
the plurality of hollow columns in the first removable spacer engage the plurality of protrusions in the second removable spacer.

4. The cupholder of claim 3, wherein:
the first spacer and the second spacer are substantially made of molded plastic.

5. The cupholder of claim 1, wherein:
the plurality of protrusions in the first spacer comprises four protrusions, each protrusion having a polygonal shape when viewed from a topside of the first spacer.

6. The cupholder of claim 1, wherein:
the fastener is a screw;
the adaptable base comprises a threaded insert to receive a portion of the screw; and
the threaded insert is substantially made of a metallic material.

7. A cupholder system for use with a vehicle, comprising:
a cupholder section having an internal volume shaped and configured to receive a beverage container;
an adaptable base having an envelope diameter and a plurality of legs configured to expand and retract whereby the envelope diameter of the adaptable base is configured to expand between a minimum envelope diameter and a maximum envelope diameter;
a first removable spacer, the first removable spacer positioned between the adaptable base and the cupholder section;
a fastener shaped and positioned to attach the cupholder section to the adaptable base, the fastener being a first fastener, wherein the first fastener passes through a first hole in the first removable spacer;
wherein the first hole is substantially in the center of the first removable spacer;
wherein the cupholder section has a plurality of recesses, and the first removable spacer has a plurality of protrusions, wherein the plurality of recesses are configured to engage a first subset of the plurality of protrusions in a first configuration and a second subset of the plurality of protrusions in a second configuration, whereby the cupholder section may be positioned on-center relative to the first removable spacer in the first configuration or off-center relative to the first removable spacer in the second configuration, respectively;
wherein the cupholder section has a first hole and a second hole, wherein the first fastener passes through the first hole when the cupholder section is in the first configuration, and wherein the first fastener passes through the second hole when the cupholder section is in the second configuration;
wherein the first hole in the cupholder section is on-center relative to the envelope diameter of the adaptable base;
none of the plurality of recesses in the cupholder section are on-center relative to the envelope diameter of the adaptable base when the cupholder section is in the first configuration and when the cupholder section is in the second configuration;
printed instructions for adding a second removable spacer;
printed instructions for removing the first removable spacer;
a second fastener configured for use when the first removable spacer is removed, whereby no spacer is in use; and
a third fastener configured for use when the second removable spacer is added, whereby two spacers are in use.

8. The cupholder system of claim 7, wherein:
the first spacer and the second spacer are substantially made of molded plastic.

9. The cupholder system of claim 7, wherein:
the plurality of protrusions in the first spacer comprises four protrusions, each protrusion having a polygonal shape when viewed from a topside of the first spacer.

10. The cupholder system of claim 7, wherein:
the first, second, and third fasteners are screws;
the adaptable base comprises a threaded insert to receive a portion one of the screws; and
the threaded insert is substantially made of a metallic material.
